(19) United States
(12) Patent Application Publication
(10) Pub. No.: US 2026/0323569 A1
(43) Pub. Date: Oct. 15, 2026

(54) INFORMATION COLLECTION SYSTEM, INFORMATION COLLECTION METHOD, INFORMATION COLLECTION SERVER, AND PROGRAM

(71) Applicant: NTT, INC., Tokyo (JP)

(72) Inventor: Haruka NAGOSHI, Musashino-shi, Tokyo (JP)

(21) Appl. No.: 19/108,484

(22) PCT Filed: Oct. 3, 2022
(86) PCT No.: PCT/JP2022/036947

§ 371 Date: Mar. 4, 2025

(51) Int. Cl. H04W 64/00

(52) U.S. Cl. CPC H04W 64/00

(57) ABSTRACT

One aspect of the present invention is an information collection system including a plurality of communication devices and an information collection server that collects information regarding the communication devices, in which the communication devices each include a detection unit that detects acquisition of information regarding the communication devices, and an information transmission unit that transmits acquisition of the information regarding the communication devices to the information collection server or a predetermined device in a case where acquisition of the information regarding the communication devices is detected by the detection unit, and the information collection server includes an information reception unit that receives information regarding the communication devices transmitted from the communication devices or the predetermined device, a position information acquisition unit that acquires position information indicating a position of the communication device to which the information regarding the communication devices received by the information reception unit has been transmitted, and a storage unit that stores information regarding the communication devices and the position information.

### TECHNICAL FIELD

The present invention relates to a technology of an information collection system, an information collection method, an information collection server, and a program.

### BACKGROUND ART

In a communication device such as an optical network unit (ONU) or an optical line terminal (OLT), error information and failure information of the device are held.

For example, information regarding errors of the device includes an error such as bit inversion caused by air shower. FIG. 34 is a diagram illustrating an example of a system for observing an air shower. The system uses a detector that detects an air shower. As the detector, a water Cherenkov detector, an atmospheric fluorescence detector, or the like is used. In the system, as illustrated in FIG. 34, a plurality of detectors is planarly arranged on the ground, and complex observation is performed.

### CITATION LIST

### Patent Literature

Patent Literature 1: WO 2021/161441 A1

### Non Patent Literature

Non Patent Literature 1: Pierre Auger Observatory A Hybrid Detector, https://www.auger.org/observatory/auger-hybrid-detector (2022.6.9, 12:35)

### SUMMARY OF INVENTION

### Technical Problem

As described above, in the communication device, various kinds of information are held for each individual communication device such as various kinds of errors occurring, but there is no mechanism for acquiring such information including position information and creating a distribution map.

In view of the above circumstances, an object of the present invention is to provide a technique for collecting various types of information from communication devices and creating a distribution map.

### Solution to Problem

An aspect of the present invention is an information collection system including a plurality of communication devices and an information collection server that collects information regarding the communication devices, in which the communication devices each include a detection unit that detects acquisition of information regarding the communication devices, and an information transmission unit that transmits acquisition of the information regarding the communication devices to the information collection server or a predetermined device in a case where acquisition of the information regarding the communication devices is detected by the detection unit, and the information collection server includes an information reception unit that receives information regarding the communication devices transmitted from the communication devices or the predetermined device, a position information acquisition unit that acquires position information indicating a position of the communication device to which the information regarding the communication devices received by the information reception unit has been transmitted, a storage unit that stores information regarding the communication devices and the position information, and a creation unit that creates a distribution map on the basis of the information regarding the communication devices stored in the storage unit and the position information.

An aspect of the present invention is an information collection method in an information collection system including a plurality of communication devices and an information collection server that collects information regarding the communication devices, in which the communication devices each include a detection step of detecting acquisition of information regarding the communication devices, and an information transmission step of transmitting acquisition of the information regarding the communication devices to the information collection server or a predetermined device in a case where acquisition of the information regarding the communication devices is detected by the detection unit, and the information collection server includes an information reception step of receiving information regarding the communication devices transmitted from the communication devices or the predetermined device, a position information acquisition step of acquiring position information indicating a position of the communication device to which the information regarding the communication devices received by the information reception unit has been transmitted, a storage step of storing information regarding the communication devices and the position information, and a creation step of creating a distribution map on the basis of the information regarding the communication devices stored in the storage unit and the position information.

An aspect of the present invention is an information collection server including an information reception unit that receives information regarding the communication device transmitted from the communication device, a position information acquisition unit that acquires position information indicating a position of the communication device to which the information regarding the communication device received by the information reception unit has been transmitted, a storage unit that stores information regarding the communication device and the position information, and a creation unit that creates a distribution map on the basis of the information regarding the communication device stored in the storage unit and the position information.

One aspect of the present invention is a program for causing a computer to function as the information collection server.

### Advantageous Effects of Invention

According to the present invention, it is possible to provide a technology capable of collecting various types of information from a communication devices.

### BRIEF DESCRIPTION OF DRAWINGS

FIG. 1 is a diagram illustrating an example configuration of an information collection system according to the present embodiment.

FIG. 2 is a diagram illustrating a configuration example of a data information collection server.

FIG. 3 is a diagram illustrating a configuration example of an error DB stored in an error information storage unit.

FIG. 4 is a diagram illustrating a configuration example of a position DB stored in a position information storage unit.

FIG. 5 is a diagram illustrating a configuration example of a terminal according to the first embodiment.

FIG. 6 is a diagram illustrating a configuration example of an OLT according to the first embodiment.

FIG. 7 is a sequence diagram illustrating processing contents in the information collection system in the first embodiment.

FIG. 8 is a diagram illustrating an example of a distribution map.

FIG. 9 is a diagram illustrating a configuration example of an OLT according to the second embodiment.

FIG. 10 is a sequence diagram illustrating processing contents in an information collection system in the second embodiment.

FIG. 11 is a sequence diagram illustrating processing contents in an information collection system in the third embodiment.

FIG. 12 is a diagram illustrating a configuration example of a terminal according to the fourth embodiment.

FIG. 13 is a sequence diagram illustrating processing contents in an information collection system in the fourth embodiment.

FIG. 14 is a diagram illustrating a configuration example of an OLT according to the fifth embodiment.

FIG. 15 is a sequence diagram illustrating processing contents in an information collection system in the fifth embodiment.

FIG. 16 is a sequence diagram illustrating processing contents in an information collection system in the sixth embodiment.

FIG. 17 is a diagram illustrating a configuration example of a terminal according to the seventh embodiment.

FIG. 18 is a diagram illustrating a configuration example of an OLT according to the seventh embodiment.

FIG. 19 is a sequence diagram illustrating processing contents in an information collection system in the seventh embodiment.

FIG. 20 is a diagram illustrating a configuration example of an OLT according to the eighth embodiment.

FIG. 21 is a sequence diagram illustrating processing contents in an information collection system in the eighth embodiment.

FIG. 22 is a diagram illustrating a configuration example of an OLT according to the ninth embodiment.

FIG. 23 is a sequence diagram illustrating processing contents in an information collection system in the ninth embodiment.

FIG. 24 is a diagram illustrating a configuration example of the information collection system including a time synchronization server.

FIG. 25 is a diagram illustrating a configuration example of a terminal according to the tenth embodiment.

FIG. 26 is a diagram illustrating a configuration example of an OLT according to the tenth embodiment.

FIG. 27 is a diagram illustrating a configuration example of an OLT according to the eleventh embodiment.

FIG. 28 is a diagram illustrating a configuration example of a terminal according to the thirteenth embodiment.

FIG. 29 is a diagram illustrating a configuration example of an OLT according to the fourteenth embodiment.

FIG. 30 is a diagram illustrating a configuration example of a terminal according to the sixteenth embodiment.

FIG. 31 is a diagram illustrating a configuration example of an OLT according to the sixteenth embodiment.

FIG. 32 is a diagram illustrating a configuration example of an OLT according to the seventeenth embodiment.

FIG. 33 is a diagram illustrating a configuration example of an OLT according to the eighteenth embodiment.

FIG. 34 is a diagram illustrating an example of an information collection system that observes an air shower.

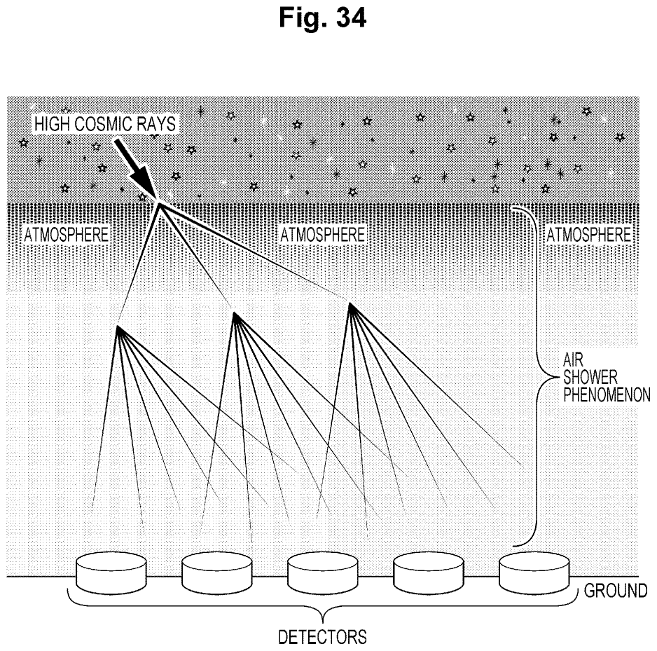

### DESCRIPTION OF EMBODIMENTS

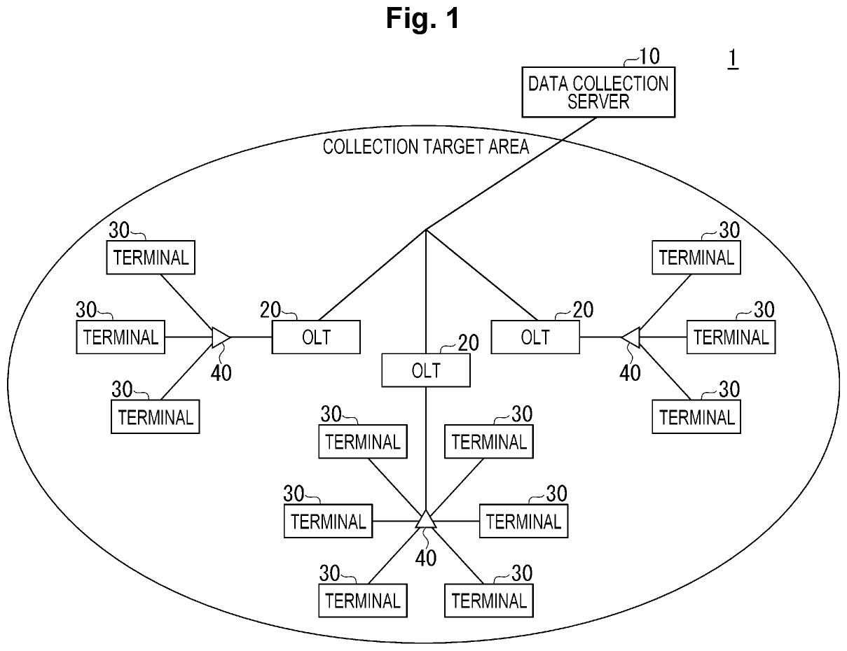

Embodiments of the present invention will be described in detail with reference to the drawings. FIG. 1 illustrates a configuration example of an information collection system 1 according to the present embodiment.

The information collection system 1 includes a data information collection server 10, a plurality of optical line terminals (OLTs) 20, and a plurality of terminals 30. An OLT 20 and a terminal 30 may be connected by wired connection using an optical fiber or a metal wire, or may be connected by wireless connection such as Wi-fi (registered trademark). In the present embodiment, a configuration example of wired connection by an optical fiber will be described. The terminal 30 is connected to the OLT 20 via an optical splitter 40. The OLT 20 is connected to the data information collection server 10.

The terminal 30 is installed in a general residence, a place of business, or the like located in a collection target area. The terminal 30 is a communicable electronic device such as an optical network unit (ONU), a personal computer, and a microwave oven. In the present embodiment, as an example of information regarding a communication device to be collected, error information regarding a soft error (for example, bit inversion of a random access memory (RAM) or the like) possibly caused by cosmic ray neutrons will be described as an example.

The terminal 30 or the OLT 20 can detect that a soft error has occurred and soft error information has been acquired. The terminal 30 transmits error information regarding the soft error to the data information collection server 10 via the OLT 20. The OLT 20 transmits error information received from the terminal 30 and error information related to a soft error detected by itself to the data information collection server 10. In the following description, a soft error may be simply referred to as an error.

The terminal 30 is an example of a communication device. The OLT 20 is an example of a communication device or a predetermined device. Specifically, the OLT 20 is an example of a predetermined device when receiving error information from the terminal 30 and transmitting the error information to the data information collection server 10. In a case where the OLT 20 transmits the error information to the data information collection server 10, the OLT 20 is an example of the communication device.

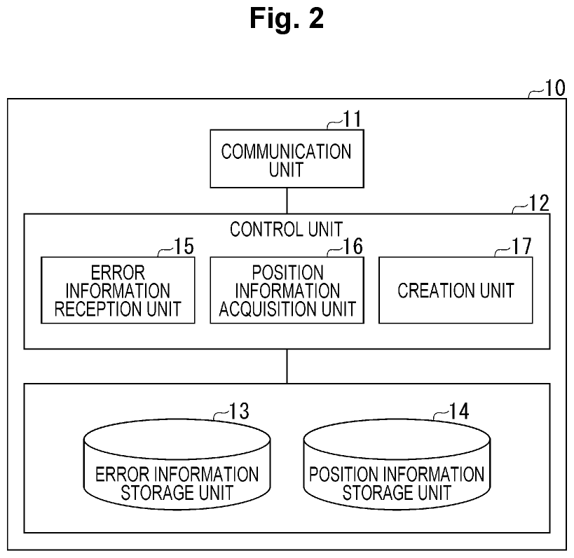

The data information collection server 10 is an example of an information collection server. FIG. 2 is a diagram illustrating a configuration example of the data information collection server 10. The data information collection server 10 includes a communication unit 11, a control unit 12, an error information storage unit 13, and a position information storage unit 14. The data information collection server 10 includes a central processing unit (CPU), a memory, an auxiliary storage device, and the like connected by a bus, and functions as a device including the communication unit 11, the error information storage unit 13, the position information storage unit 14, and the control unit 12 by executing a data collection program.

The communication unit 11 communicates with the OLT 20 and the like. The control unit 12 controls the entire data information collection server 10. The error information storage unit 13 and the position information storage unit 14 include nonvolatile storage devices such as a hard disk drive (HDD) and a solid state drive (SSD).

The control unit 12 includes an error information reception unit 15, a position information acquisition unit 16, and a creation unit 17. The error information reception unit 15 receives error information transmitted from the terminal 30 or the OLT 20. The received error information is stored in the error information storage unit 13. The position information acquisition unit 16 acquires position information indicating the position of the communication device to which the error information is transmitted. The position information is stored in the position information storage unit 14. The creation unit 17 creates a distribution map indicating an error occurrence position on the basis of the stored error information and position information.

Some or all of the functions of the control unit 12 may be implemented using hardware such as an application specific integrated circuit (ASIC), a programmable logic device (PLD), or a field programmable gate array (FPGA). The data collection program may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The data collection program may be transmitted via a telecommunication line.

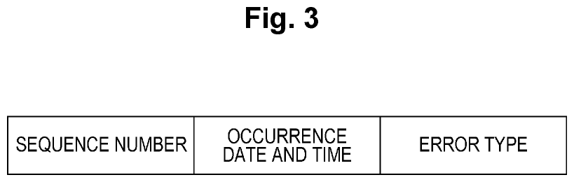

FIG. 3 is a diagram illustrating a configuration example of an error DB stored in the error information storage unit 13. The error DB includes a sequence number, occurrence date and time, and an error type. The sequence number is a unique number assigned every time the error information is received. The occurrence date and time indicates the occurrence date and time of the error. Examples of the error type include the bit inversion described above, but a type indicating an increase in noise caused by the influence of cosmic rays, an increase in power consumption, and the like may be included.

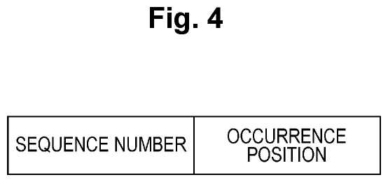

FIG. 4 is a diagram illustrating a configuration example of the position DB stored in the position information storage unit 14. The position DB includes the sequence number and the occurrence position described above. The occurrence position is information indicating the position of the terminal 30 or the OLT 20 in which the error has occurred, for example, by east longitude and north latitude. Note that the occurrence position is not limited to east longitude and north latitude, and may be, for example, an address or a zip code at which the terminal 30 or the OLT 20 in which the error has occurred is installed. The occurrence date and time, the error type, and the occurrence position are associated using the sequence number as a key.

Based on the configurations described in FIGS. 1 to 4, first to ninth embodiments will be described.

### First Embodiment

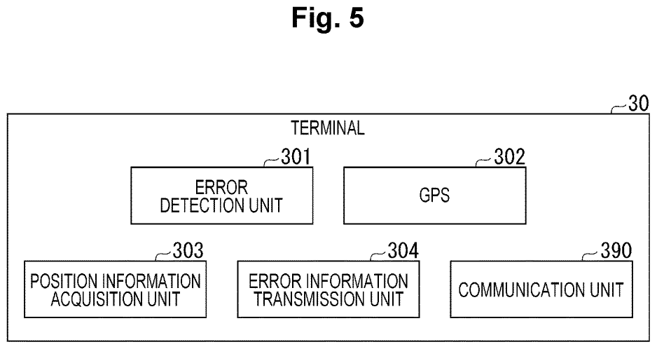

In the first embodiment, only the terminal 30 detects an error. FIG. 5 is a diagram illustrating a configuration example of the terminal 30 according to the first embodiment. The terminal 30 includes an error detection unit 301, a global positioning system (GPS) 302, a position information acquisition unit 303, an error information transmission unit 304, and a communication unit 390.

The error detection unit 301 detects that error information has been acquired. The GPS 302 detects the position (east longitude, north latitude) of the terminal 30. The position information acquisition unit 303 acquires the position detected by the GPS 302. When the error detection unit 301 detects that the error information has been acquired, the error information transmission unit 304 acquires the position information from the position information acquisition unit 303, acquires date and time information detected by using a real time clock (RTC) or the like, and transmits the date and time information to the OLT 20 by the communication unit 390. Note that it is assumed that the OLT 20 of the transmission destination is registered in advance. The communication unit 390 is, for example, a communication unit that performs optical communication, and transmits and receives optical signals.

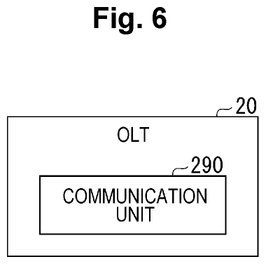

FIG. 6 is a diagram illustrating a configuration example of the OLT 20 according to the first embodiment. The OLT 20 includes a communication unit 290. The communication unit 290 is, for example, a communication unit that performs optical communication, and transmits and receives optical signals. In the first embodiment, in particular, error information or the like transmitted by the terminal 30 is transmitted to the data information collection server 10.

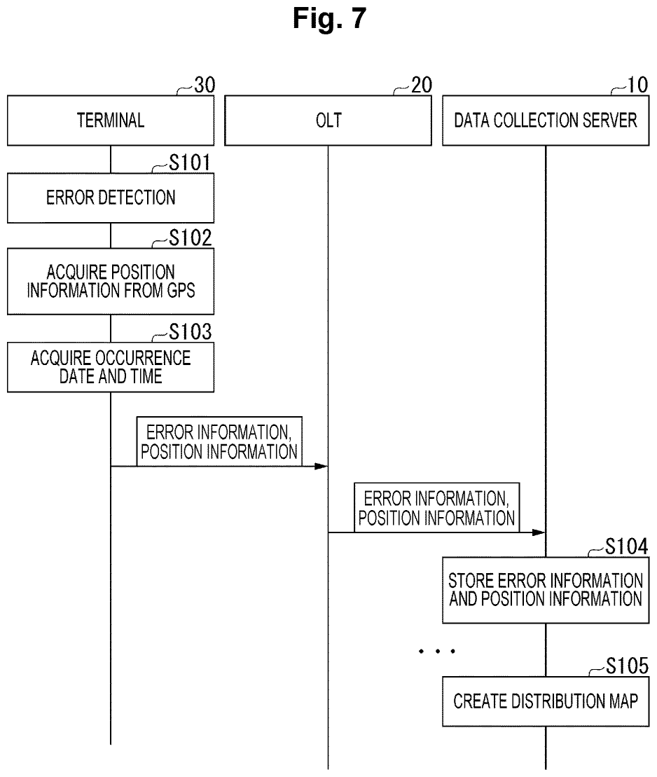

FIG. 7 is a sequence diagram illustrating processing contents in the information collection system 1 in the first embodiment. Upon detecting an error (step S101), the terminal 30 acquires position information from the GPS 302 (step S102), acquires occurrence date and time (step S103), and transmits the error information and the position information to the OLT 20. The error information here includes an error type and occurrence date and time.

Upon receiving the error information and the position information, the OLT 20 directly transmits the error information and the position information to the data information collection server 10. The data information collection server 10 stores the received error information in the error information storage unit 13, and stores the position information in the position information storage unit 14 (step S104). When the data information collection server 10 stores the error information and the position information from each terminal 30 in this manner, a distribution map is created on the basis of the error information and the position information (step S105).

According to the first embodiment, information regarding the terminal 30 can be collected.

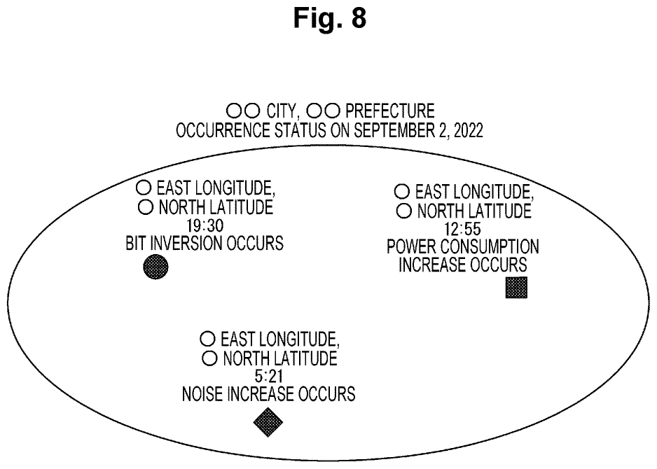

FIG. 8 is a diagram illustrating an example of a distribution map. The distribution map displays the position information and the error information on a map indicating collection target areas. As illustrated in FIG. 8, the image (circle, rhombus, or square) indicating the position may be different depending on the error type. In FIG. 8, an error occurring in a certain day is illustrated as an example, but for example, an error occurring in a period such as one month may be illustrated, or the number of occurrences in the period may be further illustrated.

### Second Embodiment

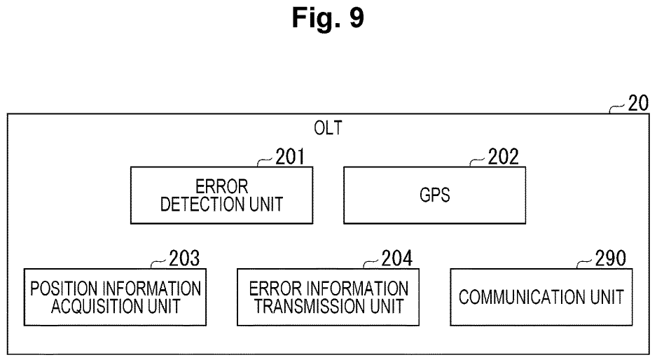

In the second embodiment, only the OLT 20 detects an error. Therefore, in the second embodiment, the configuration of the terminal 30 is omitted. FIG. 9 is a diagram illustrating a configuration example of the OLT 20 according to the second embodiment. The OLT 20 includes an error detection unit 201, a GPS 202, a position information acquisition unit 203, an error information transmission unit 204, and the communication unit 290.

The error detection unit 201 detects that error information has been acquired. The GPS 202 detects the position (east longitude, north latitude) of the OLT 20. The position information acquisition unit 203 acquires the position detected by the GPS 202. When the error detection unit 201 detects that the error information has been acquired, the error information transmission unit 204 acquires the position information acquired by the position information acquisition unit 203, acquires date and time information detected by using the RTC or the like, and transmits the date and time information to the data information collection server 10 by the communication unit 290. The communication unit 290 is, for example, a communication unit that performs optical communication, and transmits and receives optical signals.

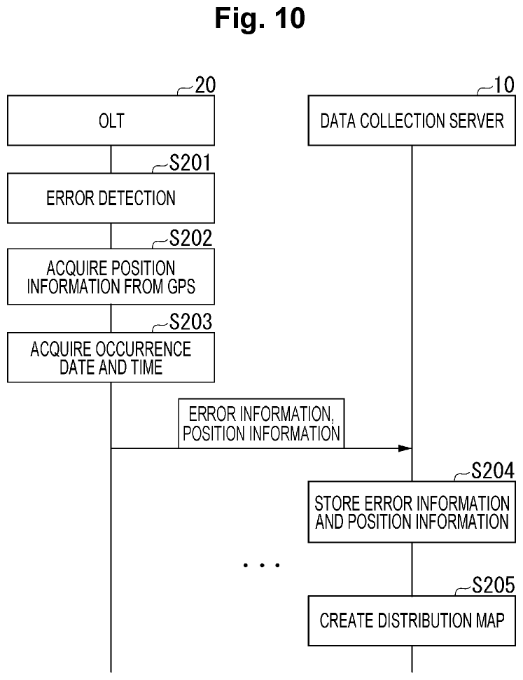

FIG. 10 is a sequence diagram illustrating processing contents in the information collection system 1 in the second embodiment. Upon detecting an error (step S201), the OLT 20 acquires the position information from the GPS 202 (step S202), acquires the occurrence date and time (step S203), and transmits the error information and the position information to the data information collection server 10. The error information here includes an error type and occurrence date and time.

The data information collection server 10 stores the received error information in the error information storage unit 13, and stores the position information in the position information storage unit 14 (step S204). When the data information collection server 10 stores the error information and the position information from each terminal 30 in this manner, the distribution map illustrated in FIG. 9 is created on the basis of the error information and the position information (step S205).

According to the second embodiment, information can be collected using the OLT 20 without providing a function such as error detection in the terminal 30.

### Third Embodiment

In the third embodiment, both the terminal 30 and the OLT 20 detect an error. The configuration of the terminal 30 in this case is the configuration illustrated in FIG. 5. The configuration of the OLT 20 is the configuration illustrated in FIG. 9.

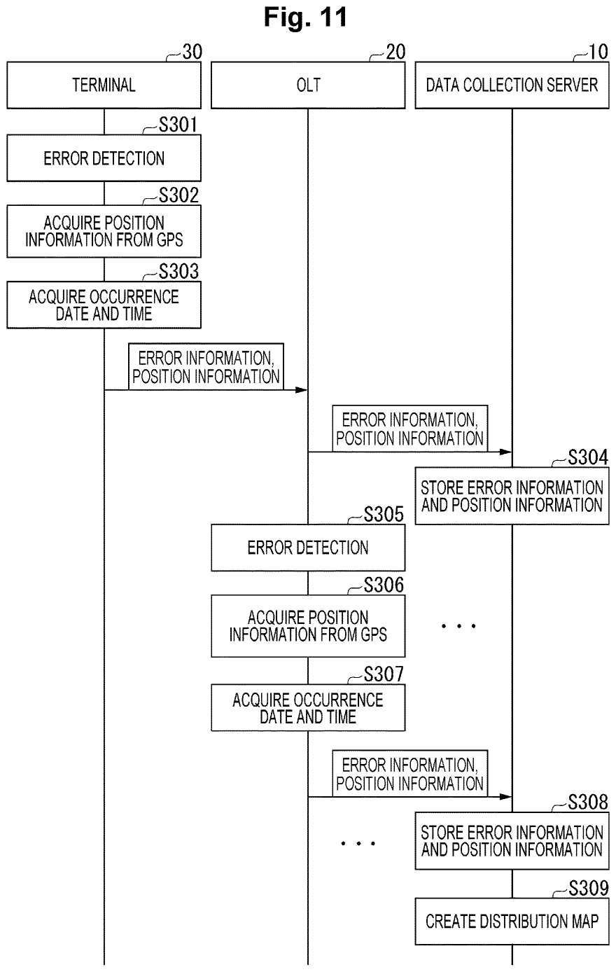

FIG. 11 is a sequence diagram illustrating processing contents in the information collection system 1 in the third embodiment. Upon detecting an error (step S301), the terminal 30 acquires the position information from the GPS 302 (step S302), acquires the occurrence date and time (step S303), and transmits the error information and the position information to the OLT 20. The error information here includes an error type and occurrence date and time.

Upon receiving the error information and the position information, the OLT 20 directly transmits the error information and the position information to the data information collection server 10. The data information collection server 10 stores the received error information in the error information storage unit 13, and stores the position information in the position information storage unit 14 (step S304).

On the other hand, upon detecting an error (step S305), the OLT 20 acquires the position information from the GPS 202 (step S306), acquires the occurrence date and time (step S307), and transmits the error information and the position information to the data information collection server 10. The error information here includes an error type and occurrence date and time.

The data information collection server 10 stores the received error information in the error information storage unit 13, and stores the position information in the position information storage unit 14 (step S308). When the data information collection server 10 stores the error information and the position information from each terminal 30 in this manner, the distribution map illustrated in FIG. 9 is created on the basis of the error information and the position information (step S209).

The sequence diagram illustrated in FIG. 11 has a flow in which, as an example, the detection by the OLT 20 is after the detection by the terminal 30, but the terminal 30 and the OLT 20 each independently detect an error and perform processing upon detection.

According to the third embodiment, information can be collected by the terminal 30 and the OLT 20. Thus, it is possible to collect information in more detail as compared with a case where information is collected by only one of the terminal 30 and the OLT 20.

### Fourth Embodiment

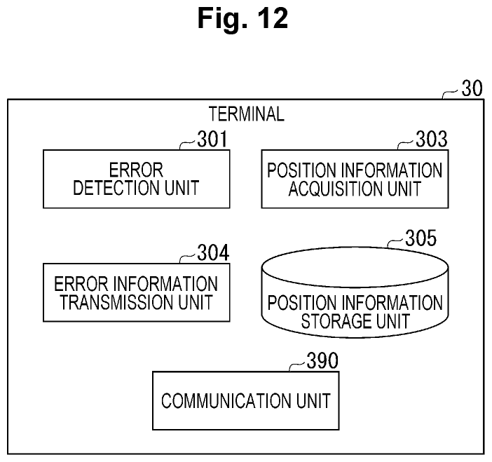

In the fourth embodiment, only the terminal 30 detects an error. Further, the terminal 30 has a mode in which a position information storage unit is provided in the terminal 30 in advance without detecting position information by the GPS 302. The position information storage unit provided in the terminal 30 stores the position information of the terminal 30. FIG. 12 is a diagram illustrating a configuration example of the terminal 30 according to the fourth embodiment. The terminal 30 includes the error detection unit 301, a position information storage unit 305, the position information acquisition unit 303, the error information transmission unit 304, and the communication unit 390.

The error detection unit 301 detects that error information has been acquired. The position information storage unit 305 stores the position (east longitude, north latitude) of the terminal 30. The position information acquisition unit 303 acquires the position stored by the position information storage unit 305. When the error detection unit 301 detects that the error information has been acquired, the error information transmission unit 304 acquires the position information from the position information acquisition unit 303, acquires date and time information detected by using the RTC or the like, and transmits the date and time information to the OLT 20 by the communication unit 390. Note that it is assumed that the OLT 20 of the transmission destination is registered in advance. The communication unit 390 is, for example, a communication unit that performs optical communication, and transmits and receives optical signals. The configuration of the OLT 20 according to the fourth embodiment is the configuration illustrated in FIG. 6.

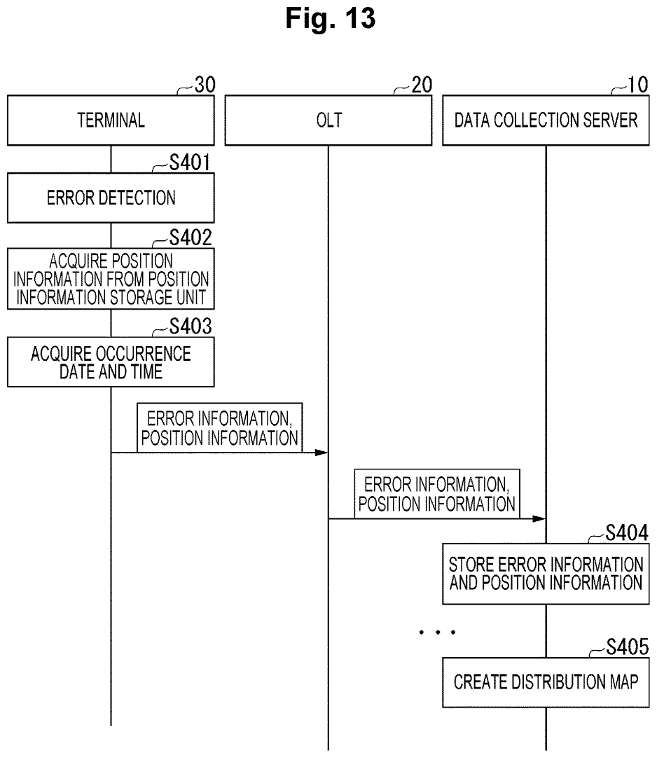

FIG. 13 is a sequence diagram illustrating processing contents in the information collection system 1 in the fourth embodiment. Upon detecting an error (step S401), the terminal 30 acquires the position information from the position information storage unit 305 (step S402), acquires the occurrence date and time (step S403), and transmits the error information and the position information to the OLT 20. The error information here includes an error type and occurrence date and time.

Upon receiving the error information and the position information, the OLT 20 directly transmits the error information and the position information to the data information collection server 10. The data information collection server 10 stores the received error information in the error information storage unit 13, and stores the position information in the position information storage unit 14 (step S404). When the data information collection server 10 stores the error information and the position information from each terminal 30 in this manner, a distribution map is created on the basis of the error information and the position information (step S405).

According to the fourth embodiment, information can be collected using the terminal 30. Further, the position information only needs to be stored in the position information storage unit 305 instead of the GPS 302. In this case, since only the memory is sufficient, the cost can be suppressed as compared with the case of using the GPS 302.

### Fifth Embodiment

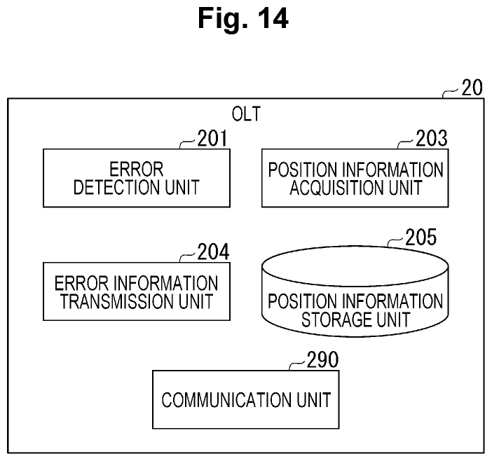

In the fifth embodiment, only the OLT 20 detects an error. Therefore, in the fifth embodiment, the configuration of the terminal 30 is omitted. FIG. 14 is a diagram illustrating a configuration example of the OLT 20 according to the fifth embodiment. The OLT 20 includes the error detection unit 201, a position information storage unit 205, the position information acquisition unit 203, the error information transmission unit 204, and the communication unit 290.

The error detection unit 201 detects that error information has been acquired. The position information storage unit 205 stores the position (east longitude, north latitude) of the OLT 20. The position information acquisition unit 203 acquires the position stored by the position information storage unit 205. When the error detection unit 201 detects that the error information has been acquired, the error information transmission unit 204 acquires the position information acquired by the position information acquisition unit 203, acquires date and time information detected by using the RTC or the like, and transmits the date and time information to the data information collection server 10 by the communication unit 290. The communication unit 290 is, for example, a communication unit that performs optical communication, and transmits and receives optical signals.

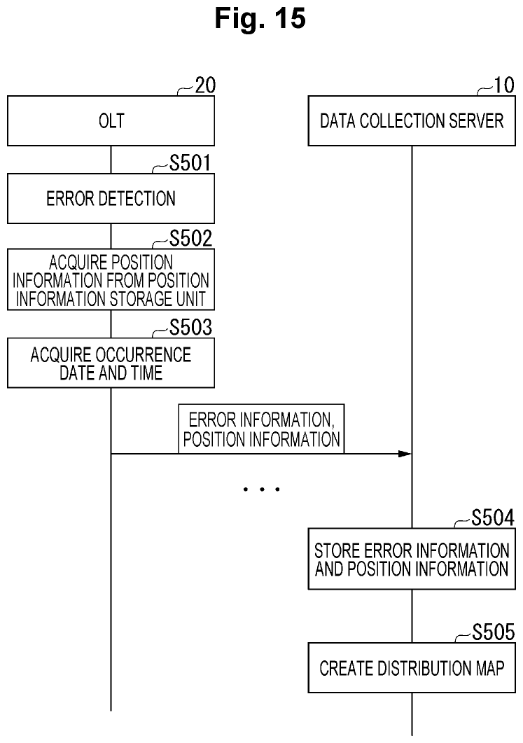

FIG. 15 is a sequence diagram illustrating processing contents in the information collection system 1 in the fifth embodiment. Upon detecting an error (step S501), the OLT 20 acquires the position information from the position information storage unit 205 (step S502), acquires the occurrence date and time (step S503), and transmits the error information and the position information to the data information collection server 10. The error information here includes an error type and occurrence date and time.

The data information collection server 10 stores the received error information in the error information storage unit 13, and stores the position information in the position information storage unit 14 (step S504). When the data information collection server 10 stores the error information and the position information from each terminal 30 in this manner, the distribution map illustrated in FIG. 9 is created on the basis of the error information and the position information (step S505).

According to the fifth embodiment, information can be collected using the OLT 20 without providing a function such as error detection in the terminal 30. Further, the position information only needs to be stored in the position information storage unit 205 instead of the GPS 202. In this case, since only the memory is sufficient, the cost can be suppressed as compared with the case of using the GPS 202.

### Sixth Embodiment

In the sixth embodiment, both the terminal 30 and the OLT 20 detect an error, and a position information storage unit is provided instead of the GPS. The configuration of the terminal 30 in this case is the configuration illustrated in FIG. 12. The configuration of the OLT 20 is the configuration illustrated in FIG. 14.

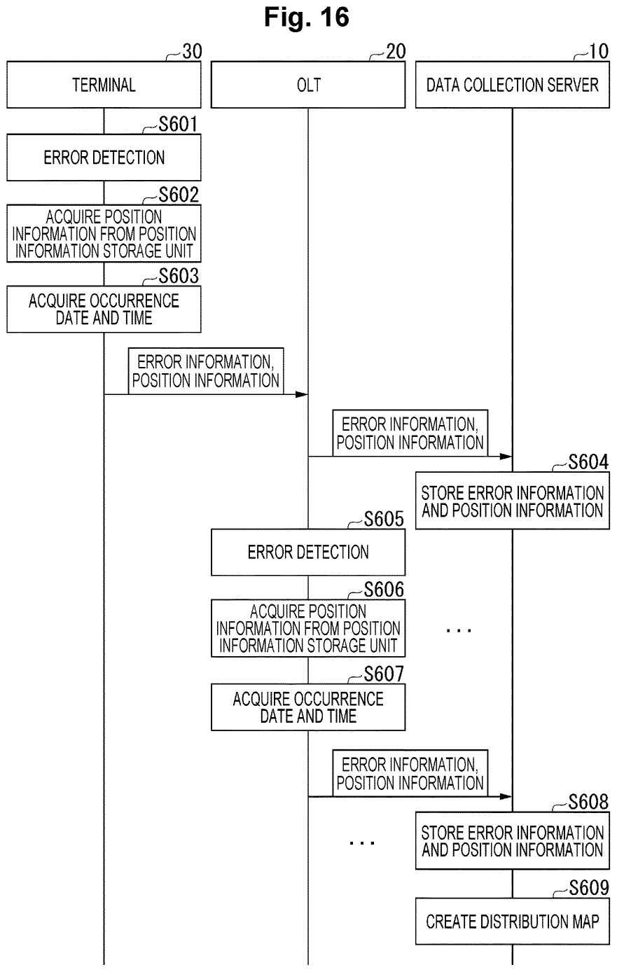

FIG. 16 is a sequence diagram illustrating processing contents in the information collection system 1 in the sixth embodiment. Upon detecting an error (step S601), the terminal 30 acquires the position information from the position information storage unit 305 (step S602), acquires the occurrence date and time (step S603), and transmits the error information and the position information to the OLT 20. The error information here includes an error type and occurrence date and time.

Upon receiving the error information and the position information, the OLT 20 directly transmits the error information and the position information to the data information collection server 10. The data information collection server 10 stores the received error information in the error information storage unit 13, and stores the position information in the position information storage unit 14 (step S604).

On the other hand, upon detecting an error (step S605), the OLT 20 acquires the position information from the position information storage unit 205 (step S606), acquires the occurrence date and time (step S607), and transmits the error information and the position information to the data information collection server 10. The error information here includes an error type and occurrence date and time.

The data information collection server 10 stores the received error information in the error information storage unit 13, and stores the position information in the position information storage unit 14 (step S608). When the data information collection server 10 stores the error information and the position information from each terminal 30 in this manner, the distribution map illustrated in FIG. 9 is created on the basis of the error information and the position information (step S209).

The sequence diagram illustrated in FIG. 11 has a flow in which, as an example, the detection by the OLT 20 is after the detection by the terminal 30, but the terminal 30 and the OLT 20 each independently detect an error and perform processing upon detection.

According to the sixth embodiment, information can be collected by the terminal 30 and the OLT 20. Thus, it is possible to collect information in more detail as compared with a case where information is collected by only one of the terminal 30 and the OLT 20. Further, the position information only needs to be stored in the position information storage units 205 and 305 instead of the GPS 202 and 302. In this case, since only the memory is sufficient, the cost can be suppressed as compared with the case of using the GPS 202 or 302.

### Seventh Embodiment

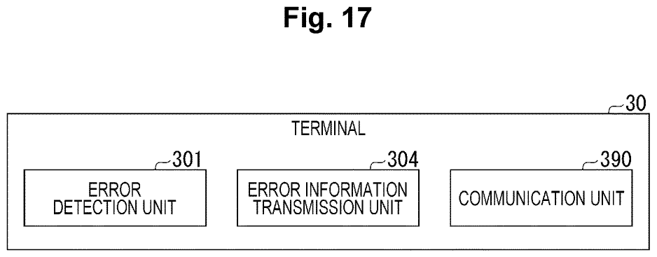

In the seventh embodiment, only the terminal 30 detects an error. In addition, the OLT 20 adds the position information. FIG. 17 is a diagram illustrating a configuration example of the terminal 30 according to the seventh embodiment. The terminal 30 includes the error detection unit 301, the error information transmission unit 304, and the communication unit 390.

The error detection unit 301 detects that error information has been acquired. When the error detection unit 301 detects that the error information has been acquired, the error information transmission unit 304 acquires date and time information detected by using the RTC or the like, and transmits the date and time information to the OLT 20 by the communication unit 390.

Note that it is assumed that the OLT 20 of the transmission destination is registered in advance. The communication unit 390 is, for example, a communication unit that performs optical communication, and transmits and receives optical signals.

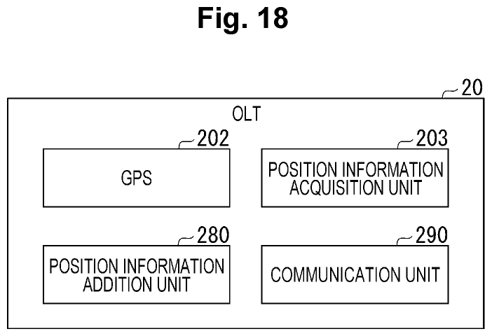

FIG. 18 is a diagram illustrating a configuration example of the OLT 20 according to the seventh embodiment. The OLT 20 includes the GPS 202, the position information acquisition unit 203, the error information transmission unit 204, a position information addition unit 280, and the communication unit 290.

The GPS 202 detects the position (east longitude, north latitude) of the OLT 20. The position information acquisition unit 203 acquires the position detected by the GPS 202. The position information addition unit 280 adds position information to error information received from the terminal 30, and transmits the error information to which the position information is added to the data information collection server 10 by the communication unit 290. The communication unit 290 is, for example, a communication unit that performs optical communication, and transmits and receives optical signals.

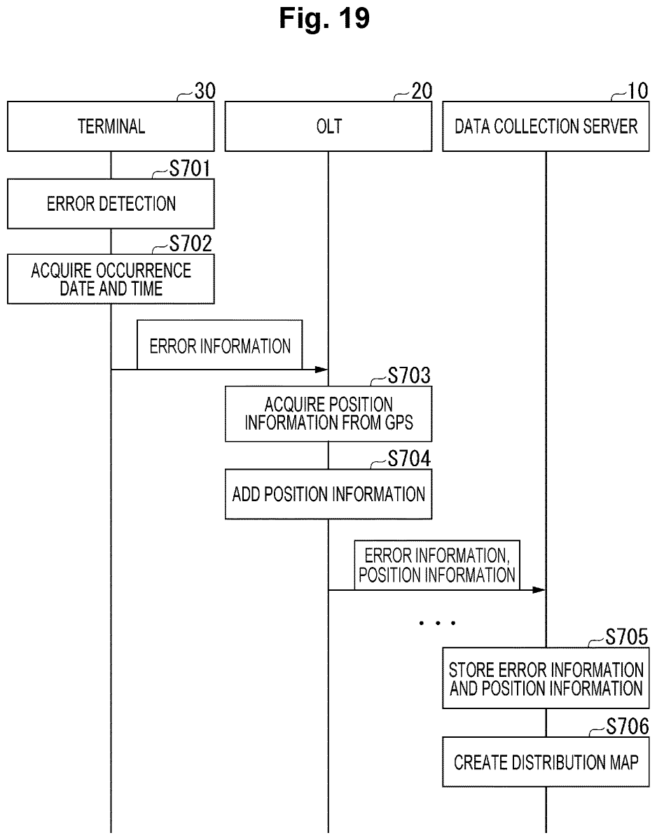

FIG. 19 is a sequence diagram illustrating processing contents in the information collection system 1 in the seventh embodiment. Upon detecting an error (step S701), the terminal 30 acquires the occurrence date and time (step S702) and transmits the error information to the OLT 20. The error information here includes an error type and occurrence date and time.

Upon receiving the error information, the OLT 20 acquires the position information from the GPS 202 (step S703), attaches the acquired position information (step S704), and transmits the error information and the position information to the data information collection server 10.

The data information collection server 10 stores the received error information in the error information storage unit 13, and stores the position information in the position information storage unit 14 (step S705). When the data information collection server 10 stores the error information and the position information from each terminal 30 in this manner, a distribution map is created on the basis of the error information and the position information (step S706).

According to the seventh embodiment, the position information is the position of the OLT 20, but for example, the OLT 20 accommodates the terminal 30 located in a circle having a predetermined radius (for example, 5 km) centered on the OLT 20. Thus, it can be seen that the information has been collected in a circle having a predetermined radius centered on the OLT 20.

According to the seventh embodiment, information can be collected using the terminal 30. In addition, since the terminal 30 does not need to acquire the position information, the cost of the terminal 30 can be reduced.

### Eighth Embodiment

In the eighth embodiment, both the terminal 30 and the OLT 20 detect an error. In addition, the OLT 20 adds the position information. The configuration of the terminal 30 in this case is the configuration illustrated in FIG. 17.

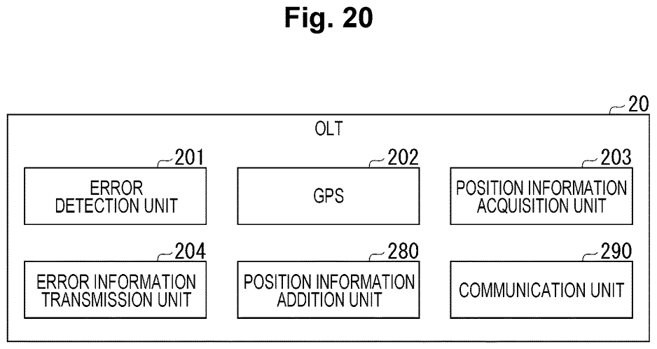

FIG. 20 is a diagram illustrating a configuration example of the OLT 20 according to the eighth embodiment.

The OLT 20 includes the error detection unit 201, the GPS 202, the position information acquisition unit 203, the error information transmission unit 204, the position information addition unit 280, and the communication unit 290.

The error detection unit 201 detects that error information has been acquired. The GPS 202 detects the position (east longitude, north latitude) of the OLT 20. The position information acquisition unit 203 acquires the position detected by the GPS 202. When the error detection unit 201 detects that the error information has been acquired, the error information transmission unit 204 acquires the position information acquired by the position information acquisition unit 203, acquires date and time information detected by using the RTC or the like, and transmits the date and time information to the data information collection server 10 by the communication unit 290. The position information addition unit 280 adds position information to the error information received from the terminal 30, and transmits the error information to which the position information is added to the data information collection server 10 by the communication unit 290. The communication unit 290 is, for example, a communication unit that performs optical communication, and transmits and receives optical signals.

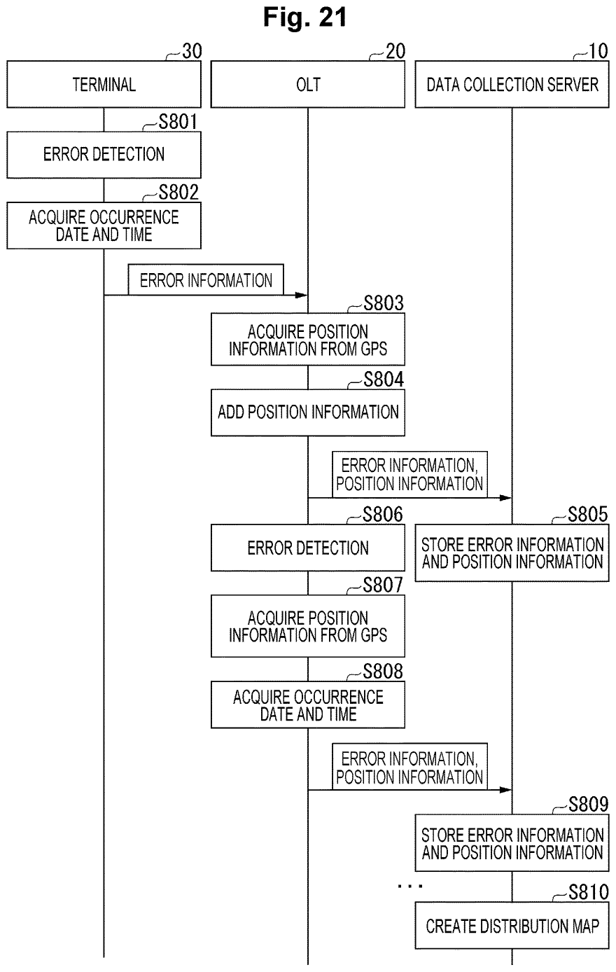

FIG. 21 is a sequence diagram illustrating processing contents in the information collection system 1 in the eighth embodiment. Upon detecting an error (step S801), the terminal 30 acquires the occurrence date and time (step S802), and transmits the error information and position information to the OLT 20. The error information here includes an error type and occurrence date and time.

Upon receiving the error information, the OLT 20 acquires the position information from the GPS 202 (step S803), attaches the acquired position information (step S804), and transmits the error information and the position information to the data information collection server 10. The data information collection server 10 stores the received error information in the error information storage unit 13, and stores the position information in the position information storage unit 14 (step S805).

On the other hand, upon detecting an error (step S806), the OLT 20 acquires the position information from the GPS 202 (step S807), acquires the occurrence date and time (step S808), and transmits the error information and the position information to the data information collection server 10. The error information here includes an error type and occurrence date and time.

The data information collection server 10 stores the received error information in the error information storage unit 13, and stores the position information in the position information storage unit 14 (step S809). When the data information collection server 10 stores the error information and the position information from each terminal 30 in this manner, the distribution map illustrated in FIG. 9 is created on the basis of the error information and the position information (step S810).

The sequence diagram illustrated in FIG. 21 has a flow in which, as an example, the detection by the OLT 20 is after the detection by the terminal 30, but the terminal 30 and the OLT 20 each independently detect an error and perform processing upon detection.

According to the eighth embodiment, the position information is the position of the OLT 20, but for example, the OLT 20 accommodates the terminal 30 located in a circle having a predetermined radius (for example, 5 km) centered on the OLT 20. Thus, it can be seen that the information has been collected in a circle having a predetermined radius centered on the OLT 20.

According to the eighth embodiment, information can be collected by the terminal 30 and the OLT 20. Thus, it is possible to collect information in more detail as compared with a case where information is collected by only one of the terminal 30 and the OLT 20. In addition, since the terminal 30 does not need to acquire the position information, the cost of the terminal 30 can be reduced.

### Ninth Embodiment

In the ninth embodiment, both the terminal 30 and the OLT 20 detect an error, and the position information storage unit is provided in the OLT 20. The configuration of the terminal 30 in this case is the configuration illustrated in FIG. 17.

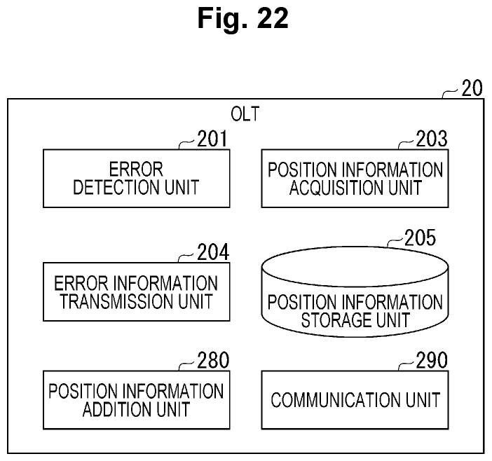

FIG. 22 is a diagram illustrating a configuration example of the OLT 20 according to the ninth embodiment.

The OLT 20 includes the error detection unit 201, the position information storage unit 205, the position information acquisition unit 203, the error information transmission unit 204, the position information addition unit 280, and the communication unit 290.

The error detection unit 201 detects that error information has been acquired. The position information storage unit 205 stores the position (east longitude, north latitude) of the OLT 20. The position information acquisition unit 203 acquires the position stored by the position information storage unit 205. When the error detection unit 201 detects that the error information has been acquired, the error information transmission unit 204 acquires the position information from the position information acquisition unit 203, acquires date and time information detected by using the RTC or the like, and transmits the date and time information to the data information collection server 10 by the communication unit 290. The position information addition unit 280 adds position information to the error information received from the terminal 30, and transmits the error information to which the position information is added to the data information collection server 10 by the communication unit 290. The communication unit 290 is, for example, a communication unit that performs optical communication, and transmits and receives optical signals.

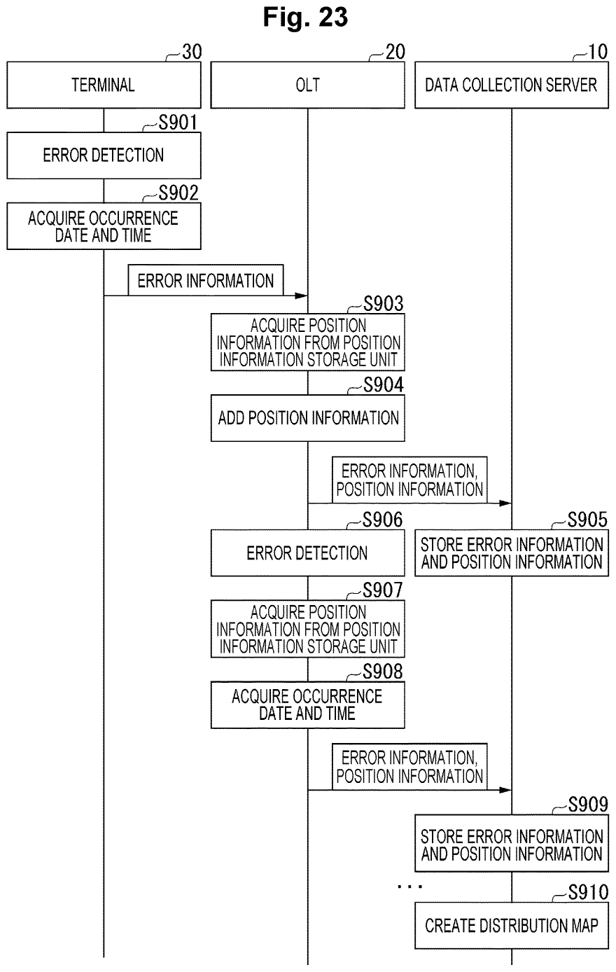

FIG. 23 is a sequence diagram illustrating processing contents in the information collection system 1 in the ninth embodiment. Upon detecting an error (step S901), the terminal 30 acquires the occurrence date and time (step S902), and transmits the error information and position information to the OLT 20. The error information here includes an error type and occurrence date and time.

Upon receiving the error information, the OLT 20 acquires the position information from the position information storage unit 205 (step S903), attaches the acquired position information (step S904), and transmits the error information and the position information to the data information collection server 10. The data information collection server 10 stores the received error information in the error information storage unit 13, and stores the position information in the position information storage unit 14 (step S905).

On the other hand, upon detecting an error (step S906), the OLT 20 acquires the position information from the position information storage unit 205 (step S907), acquires the occurrence date and time (step S908), and transmits the error information and the position information to the data information collection server 10. The error information here includes an error type and occurrence date and time.

The data information collection server 10 stores the received error information in the error information storage unit 13, and stores the position information in the position information storage unit 14 (step S909). When the data information collection server 10 stores the error information and the position information from each terminal 30 in this manner, the distribution map illustrated in FIG. 9 is created on the basis of the error information and the position information (step S910).

The sequence diagram illustrated in FIG. 23 has a flow in which, as an example, the detection by the OLT 20 is after the detection by the terminal 30, but the terminal 30 and the OLT 20 each independently detect an error and perform processing upon detection.

According to the ninth embodiment, the position information is the position of the OLT 20, but for example, the OLT 20 accommodates the terminal 30 located in a circle having a predetermined radius (for example, 5 km) centered on the OLT 20. Thus, it can be seen that the information has been collected in a circle having a predetermined radius centered on the OLT 20.

Further, the position information only needs to be stored in the position information storage unit 205 instead of the GPS 202. In this case, since only the memory is sufficient, the cost can be suppressed as compared with the Case of using the GPS 302.

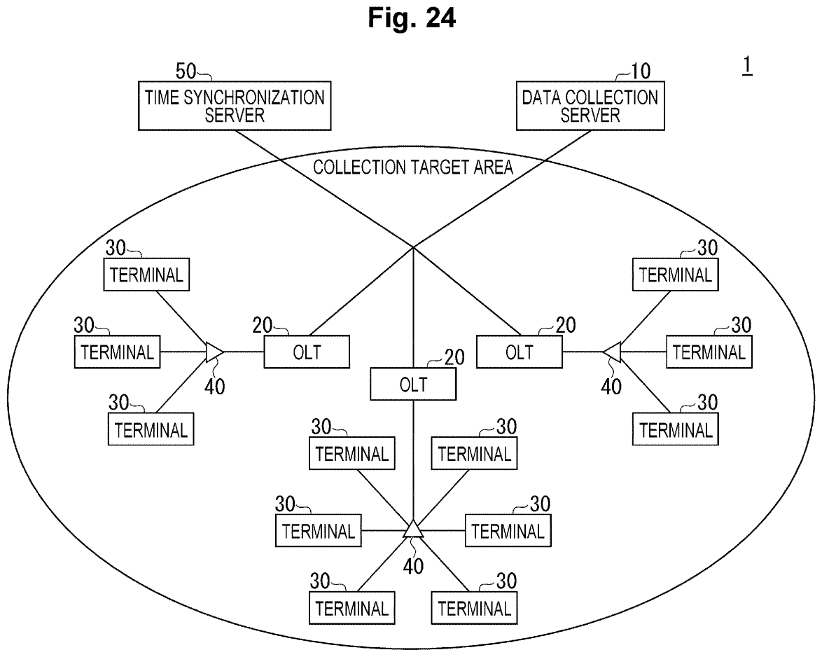

Next, an embodiment in which a time synchronization server is provided in the information collection system 1 described with reference to FIG. 1 will be described. FIG. 24 is a diagram illustrating a configuration example of the information collection system 1 including a time synchronization server 50. In the information collection system 1, the OLT 20 can access the time synchronization server 50.

Based on the configurations described in FIGS. 24 and 2 to 4, tenth to eighteenth embodiments will be described.

### Tenth Embodiment

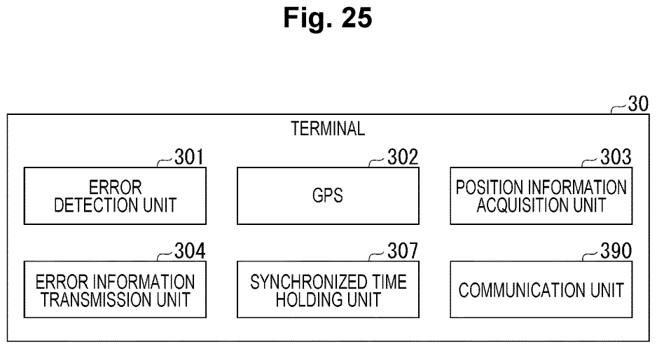

In the tenth embodiment, only the terminal 30 detects an error. FIG. 25 is a diagram illustrating a configuration example of the terminal 30 according to the tenth embodiment. The terminal 30 includes the error detection unit 301, the GPS 302, the position information acquisition unit 303, the error information transmission unit 304, a synchronized time holding unit 307, and the communication unit 390.

The error detection unit 301 detects that error information has been acquired. The GPS 302 detects the position (east longitude, north latitude) of the terminal 30. The position information acquisition unit 303 acquires the position detected by the GPS 302. The synchronized time holding unit 307 synchronizes the time by the OLT 20 whose time is synchronized by the time synchronization server 50. Time synchronization is performed, for example, at a set timing. When the error detection unit 301 detects that the error information has been acquired, the error information transmission unit 304 acquires the position information from the position information acquisition unit 303, acquires the date and time information synchronized by the synchronized time holding unit 307, and transmits the date and time information to the OLT 20 by the communication unit 390. Note that it is assumed that the OLT 20 of the transmission destination is registered in advance. The communication unit 390 is, for example, a communication unit that performs optical communication, and transmits and receives optical signals.

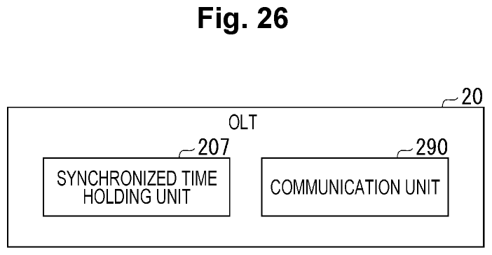

FIG. 26 is a diagram illustrating a configuration example of the OLT 20 according to the tenth embodiment. The OLT 20 includes a synchronized time holding unit 207 and the communication unit 290. The synchronized time holding unit 207 synchronizes the time by the time synchronization server 50. Time synchronization is performed, for example, at a set timing. Furthermore, the synchronized time holding unit 207 synchronizes the time with the terminal 30. The communication unit 290 is, for example, a communication unit that performs optical communication, and transmits and receives optical signals. In the tenth embodiment, in particular, error information or the like transmitted by the terminal 30 is transmitted to the data information collection server 10.

A sequence diagram illustrating processing contents in the information collection system 1 in the tenth embodiment is similar to the sequence diagram illustrated in FIG. 7, and thus is omitted.

According to the tenth embodiment, information can be collected using the terminal 30. Furthermore, by synchronizing the time with the time synchronization server 50, the data information collection server 10 can create the distribution map with more accurate date and time.

### Eleventh Embodiment

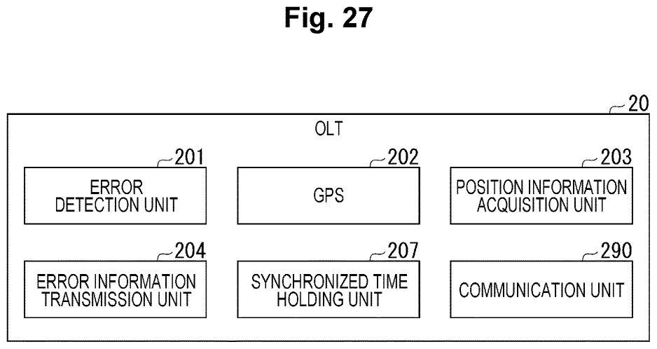

In the eleventh embodiment, only the OLT 20 detects an error. Therefore, in the eleventh embodiment, the configuration of the terminal 30 is omitted. FIG. 27 is a diagram illustrating a configuration example of the OLT 20 according to the eleventh embodiment. The OLT 20 includes the error detection unit 201, the GPS 202, the position information acquisition unit 203, the error information transmission unit 204, the synchronized time holding unit 207, and the communication unit 290.

The error detection unit 201 detects that error information has been acquired. The GPS 202 detects the position (east longitude, north latitude) of the OLT 20. The position information acquisition unit 203 acquires the position detected by the GPS 202. The synchronized time holding unit 207 synchronizes the time by the time synchronization server 50. Time synchronization is performed, for example, at a set timing. When the error detection unit 201 detects that the error information has been acquired, the error information transmission unit 204 acquires the position information acquired by the position information acquisition unit 203, acquires the date and time information synchronized by the synchronized time holding unit 207, and transmits the date and time information to the data information collection server 10 by the communication unit 290. The communication unit 290 is, for example, a communication unit that performs optical communication, and transmits and receives optical signals.

A sequence diagram illustrating processing contents in the information collection system 1 in the eleventh embodiment is similar to the sequence diagram illustrated in FIG. 10, and thus is omitted.

According to the eleventh embodiment, information can be collected using the OLT 20 without providing a function such as error detection in the terminal 30.

Furthermore, by synchronizing the time with the time synchronization server 50, the data information collection Server 10 can create the distribution map with more accurate date and time.

### Twelfth Embodiment

In the twelfth embodiment, both the terminal 30 and the OLT 20 detect an error. The configuration of the terminal 30 in this case is the configuration illustrated in FIG. 25. The configuration of the OLT 20 is the configuration illustrated in FIG. 27. A sequence diagram illustrating processing contents in the information collection system 1 in the twelfth embodiment is similar to the sequence diagram illustrated in FIG. 11, and thus is omitted.

According to the twelfth embodiment, information can be collected by the terminal 30 and the OLT 20. Thus, it is possible to collect information in more detail as compared with a case where information is collected by only one of the terminal 30 and the OLT 20. Furthermore, by synchronizing the time with the time synchronization server 50, the data information collection server 10 can create the distribution map with more accurate date and time.

### Thirteenth Embodiment

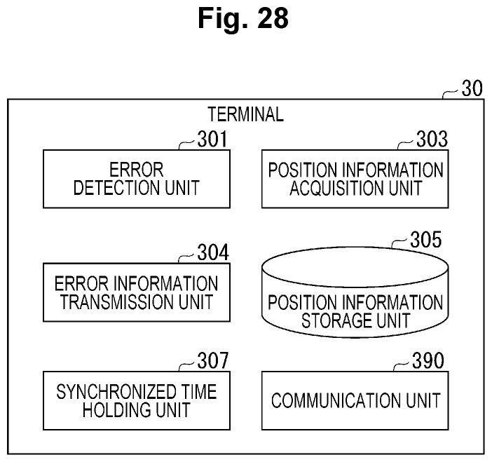

In the thirteenth embodiment, only the terminal 30 detects an error. Further, the terminal 30 has a mode in which a position information storage unit is provided in the terminal 30 in advance without detecting position information by the GPS 302. The position information storage unit provided in the terminal 30 stores the position information of the terminal 30. FIG. 28 is a diagram illustrating a configuration example of the terminal 30 according to the thirteenth embodiment. The terminal 30 includes the error detection unit 301, the position information storage unit 305, the position information acquisition unit 303, the error information transmission unit 304, the synchronized time holding unit 307, and the communication unit 390.

The error detection unit 301 detects that error information has been acquired. The position information storage unit 305 stores the position (east longitude, north latitude) of the terminal 30. The position information acquisition unit 303 acquires the position stored by the position information storage unit 305. The synchronized time holding unit 307 synchronizes the time by the OLT 20 whose time is synchronized by the time synchronization server 50. Time synchronization is performed, for example, at a set timing. When the error detection unit 301 detects that the error information has been acquired, the error information transmission unit 304 acquires the position information from the position information acquisition unit 303, acquires the date and time information synchronized by the synchronized time holding unit 307, and transmits the date and time information to the OLT 20 by the communication unit 390. Note that it is assumed that the OLT 20 of the transmission destination is registered in advance. The communication unit 390 is, for example, a communication unit that performs optical communication, and transmits and receives optical signals. The configuration of the OLT 20 according to the thirteenth embodiment is the configuration illustrated in FIG. 26.

A sequence diagram illustrating processing contents in the information collection system 1 in the thirteenth embodiment is similar to the sequence diagram illustrated in FIG. 13, and thus is omitted.

According to the thirteenth embodiment, information can be collected using the terminal 30. Further, the position information only needs to be stored in the position information storage unit 305 instead of the GPS 302. In this case, since only the memory is sufficient, the cost can be suppressed as compared with the case of using the GPS 302. Furthermore, by synchronizing the time with the time synchronization server 50, the data information collection server 10 can create the distribution map with more accurate date and time.

### Fourteenth Embodiment

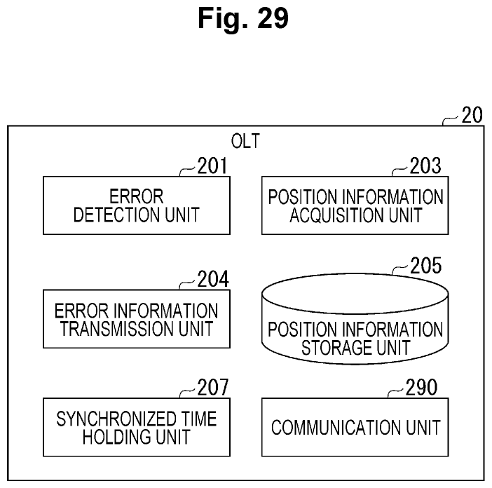

In the fourteenth embodiment, only the OLT 20 detects an error. Therefore, in the fourteenth embodiment, the configuration of the terminal 30 is omitted. FIG. 29 is a diagram illustrating a configuration example of the OLT 20 according to the fourteenth embodiment. The OLT 20 includes the error detection unit 201, the position information storage unit 205, the position information acquisition unit 203, the error information transmission unit 204, the synchronized time holding unit 207, and the communication unit 290.

The error detection unit 201 detects that error information has been acquired. The position information storage unit 205 stores the position (east longitude, north latitude) of the OLT 20. The position information acquisition unit 203 acquires the position stored by the position information storage unit 205. The synchronized time holding unit 207 synchronizes the time by the time synchronization server 50. Time synchronization is performed, for example, at a set timing. When the error detection unit 201 detects that the error information has been acquired, the error information transmission unit 204 acquires the position information acquired by the position information acquisition unit 203, acquires the date and time information synchronized by the synchronized time holding unit 207, and transmits the date and time information to the data information collection server 10 by the communication unit 290. The communication unit 290 is, for example, a communication unit that performs optical communication, and transmits and receives optical signals.

A sequence diagram illustrating processing contents in the information collection system 1 in the fourteenth embodiment is similar to the sequence diagram illustrated in FIG. 15, and thus is omitted.

According to the fourteenth embodiment, information can be collected using the OLT 20 without providing a function such as error detection in the terminal 30. Further, the position information only needs to be stored in the position information storage unit 205 instead of the GPS 202. In this case, since only the memory is sufficient, the cost can be suppressed as compared with the case of using the GPS 202. Furthermore, by synchronizing the time with the time synchronization server 50, the data information collection server 10 can create the distribution map with more accurate date and time.

### Fifteenth Embodiment

In the fifteenth embodiment, both the terminal 30 and the OLT 20 detect an error, and a position information storage unit is provided instead of the GPS. The configuration of the terminal 30 in this case is the configuration illustrated in FIG. 28. The configuration of the OLT 20 is the configuration illustrated in FIG. 29.

A sequence diagram illustrating processing contents in the information collection system 1 in the fifteenth embodiment is similar to the sequence diagram illustrated in FIG. 16, and thus is omitted.

According to the fifteenth embodiment, information can be collected by the terminal 30 and the OLT 20. Thus, it is possible to collect information in more detail as compared with a case where information is collected by only one of the terminal 30 and the OLT 20. Further, the position information only needs to be stored in the position information storage units 205 and 305 instead of the GPS 202 and 302. In this case, since only the memory is sufficient, the cost can be suppressed as compared with the case of using the GPS 202 or 302. Furthermore, by synchronizing the time with the time synchronization server 50, the data information collection server 10 can create the distribution map with more accurate date and time.

### Sixteenth Embodiment

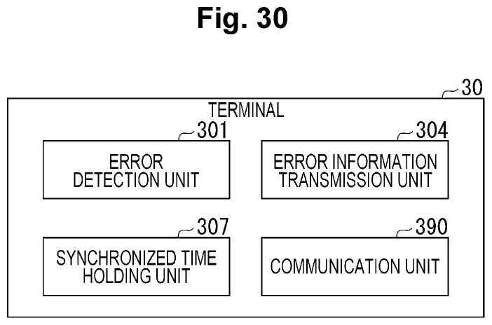

In the sixteenth embodiment, only the terminal 30 detects an error. In addition, the OLT 20 adds the position information. FIG. 30 is a diagram illustrating a configuration example of the terminal 30 according to the sixteenth embodiment. The terminal 30 includes the error detection unit 301, the error information transmission unit 304, the synchronized time holding unit 307, and the communication unit 390.

The synchronized time holding unit 307 synchronizes the time by the OLT 20 whose time is synchronized by the time synchronization server 50. Time synchronization is performed, for example, at a set timing. When the error detection unit 301 detects that the error information has been acquired, the error information transmission unit 304 acquires the date and time information synchronized by the synchronized time holding unit 307, and transmits the date and time information to the OLT 20 by the communication unit 390. Note that it is assumed that the OLT 20 of the transmission destination is registered in advance. The communication unit 390 is, for example, a communication unit that performs optical communication, and transmits and receives optical signals.

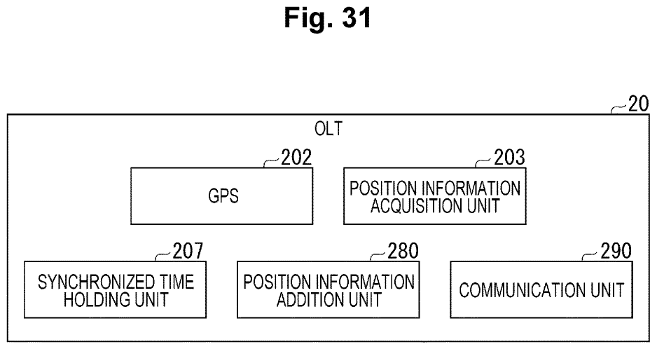

FIG. 31 is a diagram illustrating a configuration example of the OLT 20 according to the sixteenth embodiment. The OLT 20 includes the GPS 202, the synchronized time holding unit 207, the position information acquisition unit 203, the error information transmission unit 204, the position information addition unit 280, and the communication unit 290.

The GPS 202 detects the position (east longitude, north latitude) of the OLT 20. The position information acquisition unit 203 acquires the position detected by the GPS 202. The synchronized time holding unit 207 synchronizes the time by the time synchronization server 50. Time synchronization is performed, for example, at a set timing. Furthermore, the synchronized time holding unit 207 synchronizes the time with the terminal 30. The position information addition unit 280 adds position information to the error information received from the terminal 30, and transmits the error information to which the position information is added to the data information collection server 10 by the communication unit 290. The communication unit 290 is, for example, a communication unit that performs optical communication, and transmits and receives optical signals.

A sequence diagram illustrating processing contents in the information collection system 1 in the sixteenth embodiment is similar to the sequence diagram illustrated in FIG. 19, and thus is omitted.

According to the sixteenth embodiment, the position information is the position of the OLT 20, but for example, the OLT 20 accommodates the terminal 30 located in a circle having a predetermined radius (for example, 5 km) centered on the OLT 20. Thus, it can be seen that the air shower has collected information in a circle having a predetermined radius centered on the OLT 20.

According to the sixteenth embodiment, information can be collected using the terminal 30. In addition, since the terminal 30 does not need to acquire the position information, the cost of the terminal 30 can be reduced. Furthermore, by synchronizing the time with the time synchronization server 50, the data information collection server 10 can create the distribution map with more accurate date and time.

### Seventeenth Embodiment

In the seventeenth embodiment, both the terminal 30 and the OLT 20 detect an error. In addition, the OLT 20 adds the position information. The configuration of the terminal 30 in this case is the configuration illustrated in FIG. 30.

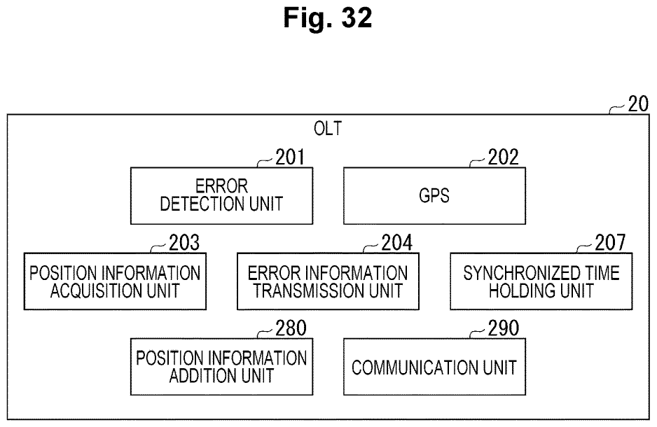

FIG. 32 is a diagram illustrating a configuration example of the OLT 20 according to the seventeenth embodiment. The OLT 20 includes the error detection unit 201, the GPS 202, the position information acquisition unit 203, the error information transmission unit 204, the synchronized time holding unit 207, the position information addition unit 280, and the communication unit 290.

The error detection unit 201 detects that error information has been acquired. The GPS 202 detects the position (east longitude, north latitude) of the OLT 20. The position information acquisition unit 203 acquires the position detected by the GPS 202. The synchronized time holding unit 207 synchronizes the time by the time synchronization server 50. Time synchronization is performed, for example, at a set timing. Furthermore, the synchronized time holding unit 207 synchronizes the time with the terminal 30. When the error detection unit 201 detects that the error information has been acquired, the error information transmission unit 204 acquires the position information acquired by the position information acquisition unit 203, acquires the date and time information synchronized by the synchronized time holding unit 207, and transmits the date and time information to the data information collection server 10 by the communication unit 290. The position information addition unit 280 adds position information to the error information received from the terminal 30, and transmits the error information to which the position information is added to the data information collection server 10 by the communication unit 290. The communication unit 290 is, for example, a communication unit that performs optical communication, and transmits and receives optical signals.

A sequence diagram illustrating processing contents in the information collection system 1 in the seventeenth embodiment is similar to the sequence diagram illustrated in FIG. 21, and thus is omitted.

According to the seventeenth embodiment, the position information is the position of the OLT 20, but for example, the OLT 20 accommodates the terminal 30 located in a circle having a predetermined radius (for example, 5 km) centered on the OLT 20. Thus, it can be seen that the information has been collected in a circle having a predetermined radius centered on the OLT 20.

According to the seventeenth embodiment, information can be collected by the terminal 30 and the OLT 20. Thus, it is possible to collect information in more detail as compared with a case where information is collected by only one of the terminal 30 and the OLT 20. In addition, since the terminal 30 does not need to acquire the position information, the cost of the terminal 30 can be reduced. Furthermore, by synchronizing the time with the time synchronization server 50, the data information collection server 10 can create the distribution map with more accurate date and time.

### Eighteenth Embodiment

In the eighteenth embodiment, both the terminal 30 and the OLT 20 detect an error, and the OLT 20 is provided with a position information storage unit. The configuration of the terminal 30 in this case is the configuration illustrated in FIG. 30.

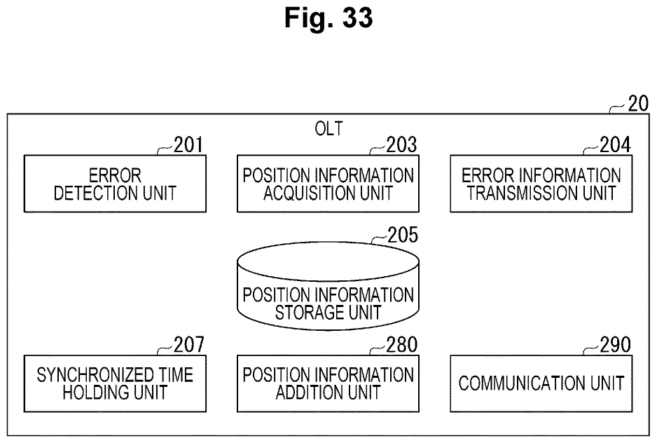

FIG. 33 is a diagram illustrating a configuration example of the OLT 20 according to the eighteenth embodiment. The OLT 20 includes the error detection unit 201, the position information storage unit 205, the position information acquisition unit 203, the error information transmission unit 204, the synchronized time holding unit 207, the position information addition unit 280, and the communication unit 290.

The error detection unit 201 detects that error information has been acquired. The position information storage unit 205 stores the position (east longitude, north latitude) of the OLT 20. The position information acquisition unit 203 acquires the position stored by the position information storage unit 205. The synchronized time holding unit 207 synchronizes the time by the time synchronization server 50. Time synchronization is performed, for example, at a set timing. Furthermore, the synchronized time holding unit 207 synchronizes the time with the terminal 30. When the error detection unit 201 detects that the error information has been acquired, the error information transmission unit 204 acquires the position information acquired by the position information acquisition unit 203, acquires the date and time information synchronized by the synchronized time holding unit 207, and transmits the date and time information to the data information collection server 10 by the communication unit 290. The communication unit 290 is, for example, a communication unit that performs optical communication, and transmits and receives optical signals.

A sequence diagram illustrating processing contents in the information collection system 1 in the eighteenth embodiment is similar to the sequence diagram illustrated in FIG. 23, and thus is omitted.

According to the eighteenth embodiment, the position information is the position of the OLT 20, but for example, the OLT 20 accommodates the terminal 30 located in a circle having a predetermined radius (for example, 5 km) centered on the OLT 20. Thus, it can be seen that the information has been collected in a circle having a predetermined radius centered on the OLT 20.

Further, the position information only needs to be stored in the position information storage unit 205 instead of the GPS 202. In this case, since only the memory is sufficient, the cost can be suppressed as compared with the case of using the GPS 302. Furthermore, by synchronizing the time with the time synchronization server 50, the data information collection server 10 can create the distribution map with more accurate date and time.

### Creation of Distribution Map

As an example of creating the distribution map, some thresholds as a reference for displaying the error information may be provided, and whether or not it is displayed may be determined by the thresholds. Examples of the threshold include an occurrence frequency per unit time. For example, a threshold of N times per day may be set, and in a case where the number of times is less than N times, it may be determined that the error information is not displayed. Examples of the other threshold include the number of terminals 30 subordinate to the OLT 20. For example, a threshold that the number of subordinate terminals 30 of the OLT 20 is 30 is provided, and it may be determined that the error information is not displayed when it is less than M.

In the embodiment described above, the error information is taken as an example of the information regarding the communication device, but the information is not limited thereto. For example, the information regarding the communication device includes setting information regarding a network. In this case, for example, the detection unit may detect that the setting information has been changed and transmit the setting information to the data collection server 10.

The error information reception unit 15, the position information acquisition unit 16, and the creation unit 17 in the data information collection server 10 may be configured using a processor such as a central processing unit (CPU) and a memory. In this case, the error information reception unit 15, the position information acquisition unit 16, and the creation unit 17 function as the error information reception unit 15, the position information acquisition unit 16, and the creation unit 17 by the processor executing a program. All or some of the functions of the error information reception unit 15, the position information acquisition unit 16, and the creation unit 17 may be implemented by using hardware such as an application specific integrated circuit (ASIC), a programmable logic device (PLD), or a field programmable gate array (FPGA). The above program may be recorded in a computer-readable recording medium. The computer-readable recording medium is, for example, a portable medium such as a flexible disk, a magneto-optical disc, a ROM, a CD-ROM, or a semiconductor storage device (for example, a solid state drive (SSD) ), or a storage device such as a hard disk or a semiconductor storage device built into a computer system. The program may be transmitted via a telecommunication line.

Although the embodiments of the present invention have been described in detail with reference to the drawings, specific configurations are not limited to the embodiments and include design and the like within the gist of the present invention.

### INDUSTRIAL APPLICABILITY

The present invention is applicable to a system that collects information from a communication device.

### REFERENCE SIGNS LIST

1 Information collection system
10 Data information collection server
11 Communication unit
12 Control unit
15 Error information reception unit
16 Position information acquisition unit
17 Creation unit
20 OLT
30 Terminal
201, 301 Error detection unit
203, 303 Position information acquisition unit
204, 304 Error information transmission unit

1. An information collection system comprising a plurality of communication devices and an information collection server that collects information regarding the communication devices, wherein
the communication devices each include
a detection unit, including one or more processors, that is configured to detect acquisition of information regarding the communication devices, and
an information transmission unit, including one or more processors, that is configured to transmit acquisition of the information regarding the communication devices to the information collection server or a predetermined device in a case where acquisition of the information regarding the communication devices is detected by the detection unit, and
the information collection server includes
an information reception unit, including one or more processors, that is configured to receive information regarding the communication devices transmitted from the communication devices or the predetermined device,
a position information acquisition unit, including one or more processors, that is configured to acquire position information indicating a position of the communication device to which the information regarding the communication devices received by the information reception unit has been transmitted,
a storage unit that is configured to store information regarding the communication devices and the position information, and
a creation unit, including one or more processors, that is configured to create a distribution map on a basis of the information regarding the communication devices stored in the storage unit and the position information.

2. The information collection system according to claim 1, wherein the communication device is configured to:
acquire position information indicating a position of the communication device; and
transmit the position information together with information regarding the communication device.

3. The information collection system according to claim 1, wherein the predetermined device is configured to:
acquire position information indicating a position of the predetermined device; and
transmit the position information together with the information regarding the communication device.

4. The information collection system according to claim 1, wherein
the information regarding the communication device includes information indicating date and time when the information regarding the communication device is detected, and
the communication device and the predetermined device are synchronized in time.

5. An information collection method in an information collection system including a plurality of communication devices and an information collection server that collects information regarding the communication devices,
the information collection method comprising:
of detecting acquisition of information regarding the communication devices;
transmitting acquisition of the information regarding the communication devices to the information collection server or a predetermined device in a case where acquisition of the information regarding the communication devices is detected by the detection unit;
receiving information regarding the communication devices transmitted from the communication devices or the predetermined device;
acquiring position information indicating a position of the communication device to which the information regarding the communication devices received by the information reception unit has been transmitted;
storing information regarding the communication devices and the position information; and
creating a distribution map on a basis of the stored information regarding the communication devices and the position information.

6. An information collection server comprising:
an information reception unit, including one or more processors, configured to receive information regarding the communication device transmitted from the communication device;
a position information acquisition unit, including one or more processors, configured to acquire position information indicating a position of the communication device to which the information regarding the communication device received by the information reception unit has been transmitted;
a storage unit that is configured to store information regarding the communication device and the position information; and
a creation unit, including one or more processors, configured to create distribution map on a basis of the information regarding the communication device stored in the storage unit and the position information.

7. (canceled)
